(19) United States
(12) Patent Application Publication
(10) Pub. No.: US 2019/0174563 A1
(43) Pub. Date: Jun. 6, 2019

(54) MULTIPLE LAYER RADIO ACCESS NETWORK DYNAMIC SLICING AND POOLING

(71) Applicant: AT&T Intellectual Property I, L.P., Atlanta, GA (US)

(72) Inventors: Sangar Dowlatkhah, Alpharetta, GA (US); Venson Shaw, Kirkland, WA (US)

(21) Appl. No.: 15/829,770

(22) Filed: Dec. 1, 2017

(51) Int. Cl. H04W 76/12; H04W 24/02

(52) U.S. Cl. CPC H04W 76/12; H04W 24/02

(57) ABSTRACT

A multiple layer dynamic slicing and pooling solution is provided for a radio access network. Access slices on a radio access network device can tunnel through a hosting layer radio device to pass control plane and user plane traffic to and from an enhancing layer radio device. A hosting layer radio device can be a 4G, 5G, or other cellular radio device, while an enhancing layer radio device can be a radio device that can be used to supplement the hosting layer radio device, providing extra capacity and coverage in a cellular network. Traditionally, enhancing layer radio device would have to be configured manually, but by tunneling through the hosting layer radio device, the core network can configure the devices automatically, providing a seamless user experience for user equipment devices attached to the mobile network.

### TECHNICAL FIELD

The present application relates generally to a field of mobile communication and, more specifically to providing a multiple layer dynamic slicing and pooling solution for a radio access network.

### BACKGROUND

To meet the huge demand for data centric applications, Third Generation Partnership Project (3GPP) systems and systems that employ one or more aspects of the specifications of the Fourth Generation (4G) standard for wireless communications will be extended to a Fifth Generation (5G) standard for wireless communications. Unique challenges exist to provide levels of service associated with forthcoming 5G and other next generation network standards.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system for providing a dynamic slicing and pooling solution for multiple layers in a radio access network in accordance with various aspects and embodiments of the subject disclosure.

FIG. 2 illustrates an example wireless communication system for providing a dynamic slicing and pooling solution for multiple layers in a radio access network in accordance with various aspects and embodiments of the subject disclosure.

FIG. 3 illustrates an example radio access network that can automatically configure enhancing layer radio devices via a hosting layer radio device in accordance with various aspects and embodiments of the subject disclosure.

FIG. 4 illustrates an example radio access network access slice that can configure and manage an enhancing layer radio device via tunneling through a hosting layer radio device in accordance with various aspects and embodiments of the subject disclosure.

FIG. 5 illustrates an example embodiment of a radio access network in accordance with various aspects and embodiments of the subject disclosure.

FIG. 6 illustrates an example embodiment of a core network in accordance with various aspects and embodiments of the subject disclosure.

FIG. 7 illustrates an example method for providing a dynamic slicing and pooling solution for multiple layers in a radio access network in accordance with various aspects and embodiments of the subject disclosure.

FIG. 8 illustrates an example method for providing a dynamic slicing and pooling solution for multiple layers in a radio access network in accordance with various aspects and embodiments of the subject disclosure.

FIG. 9 illustrates an example block diagram of an example user equipment that can be a mobile handset operable to provide a format indicator in accordance with various aspects and embodiments of the subject disclosure.

FIG. 10 illustrates an example block diagram of a computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

Various embodiments disclosed herein provide for a multiple layer dynamic slicing and pooling solution for a radio access network. Access slices on a radio access network device can tunnel through a hosting layer radio device to pass control plane and user plane traffic to and from an enhancing layer radio device. A hosting layer radio device can be a 4G, 5G, or other cellular radio device, while an enhancing layer radio device can be a radio device that can be used to supplement the hosting layer radio device, providing extra capacity and coverage in a cellular network. Traditionally, enhancing layer radio device would have to be configured manually, but by tunneling through the hosting layer radio device, the core network can configure the devices automatically, providing a seamless user experience for user equipment devices attached to the mobile network.

In today's access network solutions, there are number of alternative or added radio technologies that are available to help increase the carrier coverage or capacity in certain venues or solutions. However, each of these added solutions such as metro cell, Femtocell and Wi-Fi hot spots have their own infrastructure and path to reach the core network without the ability to incorporate a common solution or intelligent to dynamically adjust the macro and micro solutions. For instance, if there is a need to add coverage or increase capacity on a corner of a macro radio footprint, it can't be facilitated automatically or dynamically by a micro radio solution. It would be added manually and the service would be used with the new addition on a separate session or path to access the core.

The multiple layered solution disclosed herein provides for the ability to increase coverage or capacity of an 5G network. Where a main layer or “Hosting layer” directly access the network for both control and user directly through conventional protocols and interfaces. As it known that the coverage will have weak spots and in certain area will need to have need to boost it capabilities and throughput. To be able to accommodate such enhancement we need to be able to orchestrate and administrate many technologies enhance the access coverage. Every radio technology has a communication and computing capabilities by pooling these communication part of these solutions we can pool the resources in to a “enhancing layer” where all the communication for both control and user plane can tunneled through the hosting layer and can be administrated by the access slice that particular service. The tunneling through the hosting layer will enable these boosting or enhancing radio solutions to access the same radio management functions and can be orchestrated by the same core function.

Note that for simplicity we use the radio network node or simply network node is used for gNB. It refers to any type of network node that serves UE and/or connected to other network node or network element or any radio node from where UE receives signal. Examples of hosting layer radio network nodes are Node B, base station (BS), multi-standard radio (MSR) node such as MSR BS, gNB, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc. Other types of access point devices can include 6LoWPan, Wi-Fi, Range extenders, femtocells, and other enhancing layer devices.

Likewise, for reception we use the term user equipment (UE). It refers to any type of wireless device that communicates with a radio network node in a cellular or mobile communication system. Examples of UE are target device, device to device (D2D) UE, machine type UE or UE capable of machine to machine (M2M) communication, PDA, Tablet, mobile terminals, smart phone, laptop embedded equipped (LEE), laptop mounted equipment (LME), USB dongles etc. Note that the terms element, elements and antenna ports are also interchangeably used but carry the same meaning in this disclosure.

In various embodiments, a system can comprise a processor and a memory that stores executable instructions that, when executed by the processor facilitate performance of operations. The operations can comprise determining that a secondary radio device is available to provide extra coverage and extra capacity for a primary radio device beyond a current coverage and current capacity of the primary radio device, wherein the primary radio device is a cellular base station device, and the secondary radio device is a non-cellular access point device, wherein the secondary radio device is communicably coupled to a core network device via the primary radio device. The operations can also include instantiating a radio access network slice on a radio access network device that receives configuration information from the core network device. The operations can also comprise facilitating establishing a tunnel between the radio access network slice and the secondary radio device via the primary radio device. The operations can also comprise configuring the secondary radio device with the configuration information via the tunnel.

In another embodiment, method comprises determining, by a device comprising a processor, that a user equipment device is attempting to connect to an enhancing layer radio device that provides an additional coverage for a hosting layer device of a radio access network, wherein the hosting layer radio device is a cellular base station device, and the enhancing layer radio device is a non-cellular access point device. The method can also comprise instantiating, by the device, a radio access network slice on a radio access network device. The method can also comprise configuring, by the device, the enhancing layer radio device via a tunnel established between the radio access network slice and the enhancing layer radio device with configuration information received from a core network device.

In another embodiment machine-readable storage medium, comprising executable instructions that, when executed by a processor of a device, facilitate performance of operations. The operations can comprise determining that a user equipment device is attempting to connect to a secondary radio device that provides backup coverage for a coverage of a primary device of a radio access network, wherein the secondary radio device is communicably coupled to a core network device via the primary radio device. The operations can also comprise causing a radio access network slice to be instantiated on a radio access network device. The operations can also comprise configuring the secondary radio device via a tunnel established between the radio access network slice and the secondary radio device with configuration information received from the core network device.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. The mechanical parts can include sensors on a float, tilt monitors, etc. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), machine to machine, satellite, microwave, laser, Z-Wave, Zigbee and other 802.XX wireless technologies and/or legacy telecommunication technologies.

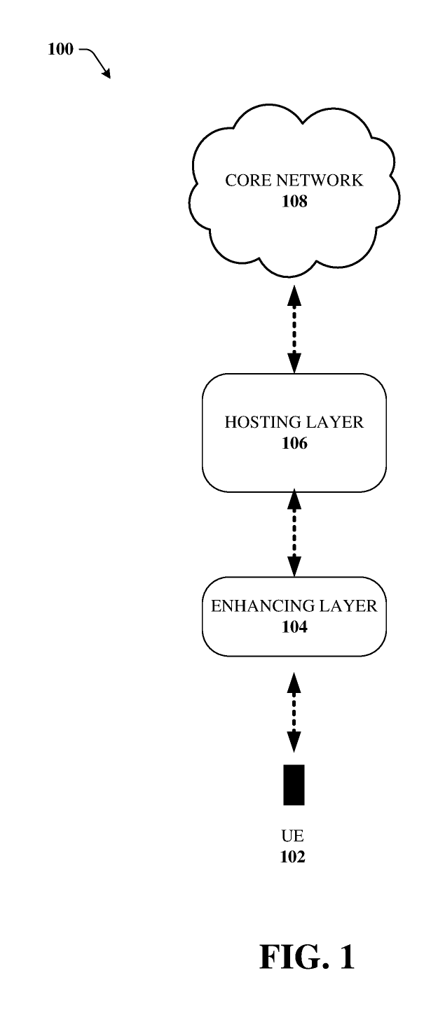

FIG. 1 illustrates an example embodiment 100 of a wireless communication system for providing a dynamic slicing and pooling solution for multiple layers in a radio access network in accordance with various aspects and embodiments of the subject disclosure. A UE device 102 can connect to a mobile network (e.g., core network 108) via an enhancing layer radio device 104 communicably coupled to a hosting layer radio device 106. The hosting layer radio device 106 can be part of a radio access network to provide coverage for the core network. A radio access network device associated with the radio access network can have one or more slices instantiated to facilitate the communications with the core network 106. Network slices are form of virtual network architecture that comprise a defined set of virtual network functions designed to facilitate one or more computing purposes. Various slices can be instantiated on the radio access network device, each of the network slices to perform a set of operations to facilitate one or more services.

Each access slice comprises an independent set of logical network functions that support the requirements of the particular use case, with the term ‘logical’ referring to software. Each slice can be optimized to provide the resources and network topology for the specific service and traffic that will use the slice. Functions such as speed, capacity, connectivity and coverage will be allocated to meet the particular demands of each use case, but functional components may also be shared across different network slices.

In an embodiment, the access slices can be used to tunnel through the hosting layer 106 in order to configure the enhancing layer radio device 104. The enhancing layer radio device 104 can be a radio device that can be used to supplement the hosting layer radio device, providing extra capacity and coverage in a cellular network such as metro cell, range extenders, Femtocell, 6LoWPan, and/or Wi-Fi access point devices.

In an embodiment, the tunneling can be performed by the access slice using Internet Protocol Security (IPsec) tunneling protocol that authenticates and encrypts the packets of data sent over a network. IPsec includes protocols for establishing mutual authentication between agents at the beginning of the session and negotiation of cryptographic keys to use during the session. IPsec can protect data flows between a pair of hosts (host-to-host), between a pair of security gateways (network-to-network), or between a security gateway and a host (network-to-host). Internet Protocol security (IPsec) uses cryptographic security services to protect communications over Internet Protocol (IP) networks. IPsec supports network-level peer authentication, data-origin authentication, data integrity, data confidentiality (encryption), and replay protection.

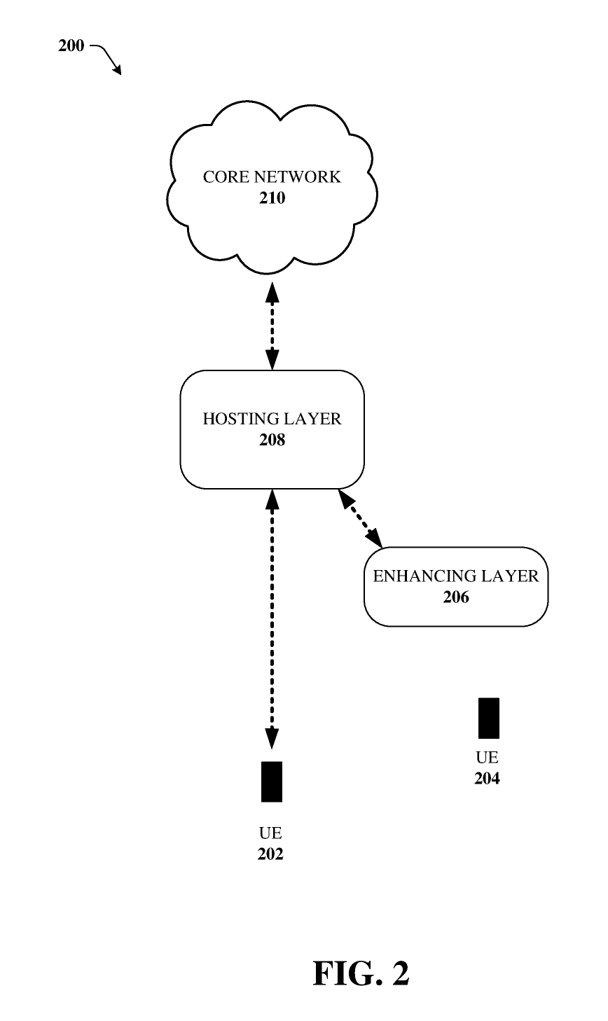

Turning now to FIG. 2, illustrated is an example embodiment 200 of a wireless communication system for providing a dynamic slicing and pooling solution for multiple layers in a radio access network in accordance with various aspects and embodiments of the subject disclosure.

In an embodiment shown in FIG. 2, hosting layer device 208 can provide connectivity to a core network 210 for UE 202. Hosting layer device 208 can also provide connectivity for UE device 204 via enhancing layer 206. A tunnel provided between a slice in the core network 210 or a radio access network and the enhancing layer 206 can allow the core network to provide configuration instructions for enhancing layer 206 and pass control plane and user plane data.

The hosting layer can provide coverage for a cell (e.g., for UE 202), but if UE 204 is outside a range of a radio associated with hosting layer 208, the signal to noise ratio of signals between hosting layer 208 and UE 204 are below a predetermined threshold and the signal to noise ratio of a signal between the enhancing layer device 206 and UE 204 is above another predetermined threshold, or the capacity of hosting layer 208 has been reached, enhancing layer 206 can be utilized as a secondary radio device, or backup radio device for the core network to assist hosting layer 208 in providing coverage for the area serviced by hosting layer 208.

A slice in the radio access network or the core network can initiate the tunnel in response to determining that an enhancing layer device 206 is available to provide extra coverage and extra capacity for a hosting layer 208, wherein the primary radio device is a cellular base station device, and the secondary radio device is a non-cellular access point device, wherein the secondary radio device is communicably coupled to a core network device via the primary radio device. The radio access network can instantiate a radio access network slice that receives configuration information from the core network 210 and then establish a tunnel to enhancing layer 206 where the radio access network slice can then configure the secondary radio device on the enhancing layer device 206.

The core network 210 can provide configuration information that matches the type of device that radio access network slice determines the enhancing layer device 206 to be. For instance, configuration instructions and format for Wi-Fi devices can be different than for Bluetooth devices, and 6LoWPan, and femtocell devices. The radio access network slice can determine the type of device by matching information received from the enhancing layer device 206 to a database of identification information. The type of radio access slice selected by the radio access network to establish the tunnel can also be based on the type of the enhancing layer device 206. In other embodiments, the type of radio access slice selected by the radio access network to establish the tunnel can also be based on the type of service requested by a user equipment device connected to the enhancing layer device 206, or requesting connection with the enhancing layer device 206.

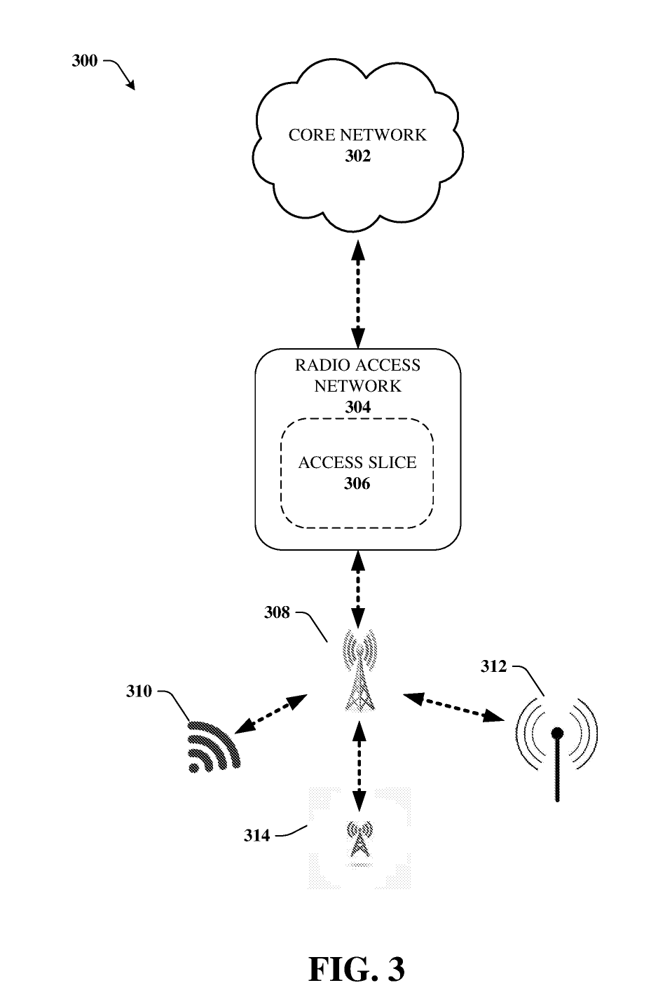

Turning now to FIG. 3, illustrated is an example embodiment 300 of a radio access network that can automatically configure enhancing layer radio devices via a hosting layer radio device in accordance with various aspects and embodiments of the subject disclosure.

A slice 306 in the radio access network 304 can initiate the tunnel in response to determining that an secondary radio device 310, 312, or 314 is available to provide extra coverage and extra capacity for a primary radio device 308, wherein the primary radio device is a cellular base station device, and the secondary radio devices can be non-cellular access point devices, wherein the secondary radio devices 310-314 are communicably coupled to a core network 302 and radio access network 304 via the primary radio device 308. The radio access network 304 can instantiate a radio access network slice 306 that receives configuration information from the core network 302 and then establish a tunnel to secondary radio device 310, 312, and 314 where the radio access network slice 306 can then configure the secondary radio devices 310-314.

The core network 302 can provide configuration information that matches the type of device that radio access network slice 306 determines the secondary radio devices 310-314 to be. For instance, configuration instructions and format for Wi-Fi devices can be different than for Bluetooth devices, and 6LoWPan, and femtocell devices. The radio access network slice 306 can determine the type of device by matching information received from the secondary radio devices 310-314 to a database of identification information. The type of radio access slice 306 selected by the radio access network 304 to establish the tunnel can also be based on the type of the secondary radio devices 310-314. In other embodiments, the type of radio access slice 306 selected by the radio access network 304 to establish the tunnel can also be based on the type of service requested by a user equipment device connected to the secondary radio devices 310-314, or requesting connection with the secondary radio devices 310-314.

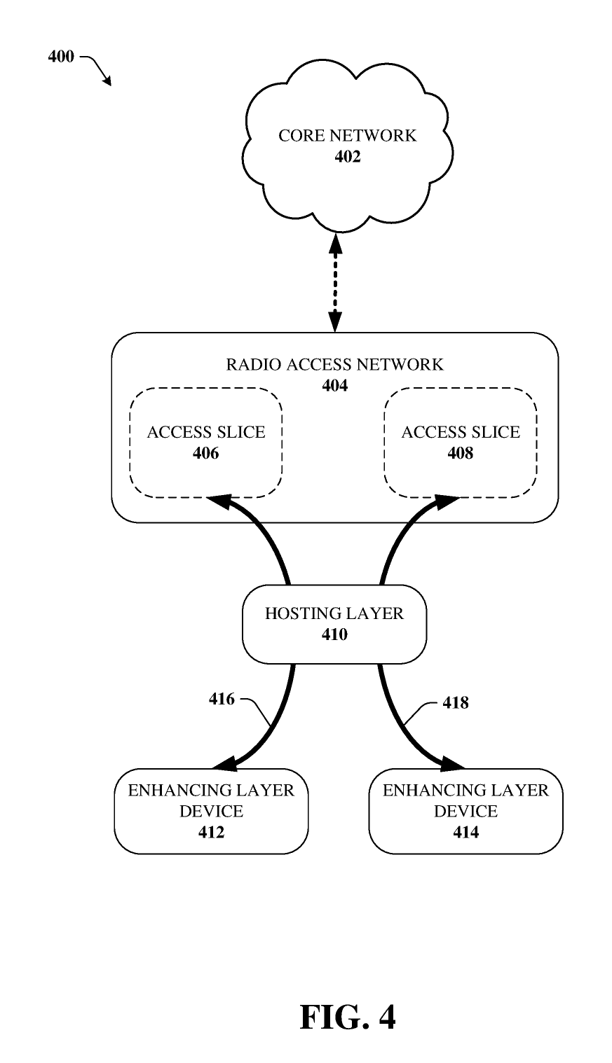

Turning now to FIG. 4, illustrated is an example embodiment 400 of a radio access network access slice that can configure and manage an enhancing layer radio device via tunneling through a hosting layer radio device in accordance with various aspects and embodiments of the subject disclosure.

In an embodiment shown in FIG. 4, a radio access network 404 can have a set of access slices 406 and 408 that each maintain tunnels 416 and 418 with enhancing layer devices 412 and 414 respectively. The tunnels can allow the core network 402 and radio access network 404 to directly configure enhancing layer devices 412 and 414 via hosting layer device 410.

In an embodiment, separate slices 406 and 408 can be instantiated by radio access network 404 as the enhancing layer devices 412 and 414 can be different types of devices. Radio access network 404 can have a set of slices to choose from when configuring enhancing layer devices, with each type of enhancing layer device corresponding to a respective slice. Radio access network 404 can determine which type of device the enhancing layer devices 412 and 414 are, then either instantiate slices 406 and 408 based on the types, or assign already operating access slices 406 and 408 to establish tunnels 416 and 418.

In other embodiments, the separate slices 406 and 408 can be due to the enhancing layer devices 412 and 414 are using different services. As an example, even if there were just one enhancing layer device, radio access network 404 can instantiate two slices and one or more tunnels to facilitate two or more services being requested by a user equipment device attached to enhancing layer device 412.

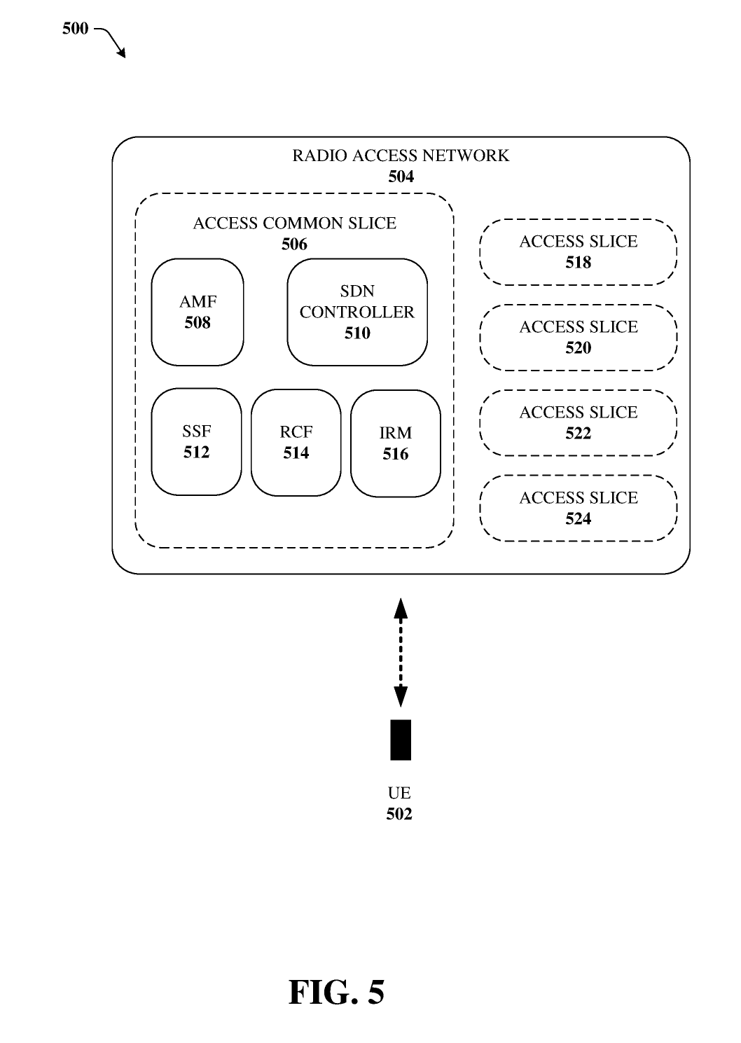

Turning now to FIG. 5, illustrated is an example embodiment 500 of a radio access network in accordance with various aspects and embodiments of the subject disclosure. The radio access network 504 can correspond to one or more of radio access networks 104, 204, 304, and/or 404.

Radio access network 504 can comprise a common slice with virtual network functions for facilitating access slice pooling and assignments. The common slice 506 can receive a request for service from a UE 502, and various virtual network functions on common slice 506 can determine information about the UE device 502, the service requested, select an access slice (e.g., access slice 518, 520, 522, and/or 524) to assign the service to, or instantiate a new access slice, as well as facilitate communications between the access slices and the core network.

In an embodiment, the common slice 506 can include an access management function 508, a slice selection function 512, a radio controller function 514, an intelligent resource management function 516, as well as an SDN controller 510. The radio controller function 514 can configure radio devices such as 4G radios, 5G radios, Wi-Fi radios, 6LoWPan radios, etc. The access management function 508 can determine which technologies should be prioritized for specific services. For example, 5G technologies can be prioritized for services with low latency requirements, while Wi-Fi can be prioritized for services that have a high bandwidth requirement. The SDN controller 510 can communicate the intelligent decisions cross service, core, backhaul and access network. The SDN controller 510 manages which radio devices the access slices have access to, and then the access slices manage the control and user plane and pass the slices to the slices in the core network.

The common slice can also include an intelligent resource management function 516 that can consider traffic load, access types (5G, 4G, 3G, Wi-Fi, etc.) and their signal strength which inline will decide traffic distribution cross available access types and slices already instantiated or available in E-comp to be instantiated. IRM 516 can also decided the optimal physical (connection with transceivers) and functional (vNFs in slices) elements. IRM 516 also will play a deciding role on which transceivers will be used on what spectrum and how much power dedicated to the transceivers. The intelligent resource management function can keep a resource management log that includes medium access control, networking, management information, baseband and digital signal processing records. This information can be used in similar circumstances for a streamlined, efficient and intelligent management of the resources. As this log keeps growing, it makes the decision making process much more efficient by referring to a similar circumstance and comparing the result and fine tuning the decision for an optimal result.

The slice selection function 512 can select an access slice from a pool of access slices to facilitate a service. The slice selection function 512 can determine which slice is appropriate based on the user equipment device 502, the type of service being requested, customer and/or subscriber account, and other information.

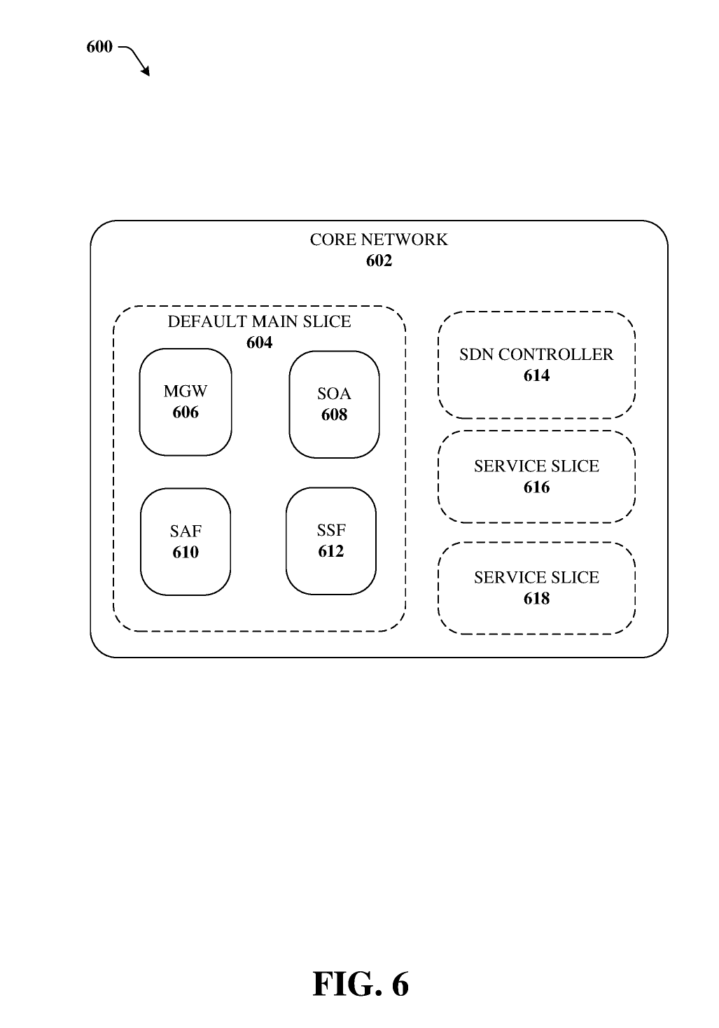

Turning now to FIG. 6, illustrated is an example embodiment 600 of a core network 602 in accordance with various aspects and embodiments of the subject disclosure.

The core network can comprise a default main slice 604 with various network functions to manage communications received from the radio access network and assign the communications to one or more service slices 610 and 612 based on the service associated with the communications. The main slice can include a slice selection function 606 which determines which service slice should handle the service requested from the user equipment device, and the SDN controller 608 can manage which communications the service slices 610 and 612 have access to.

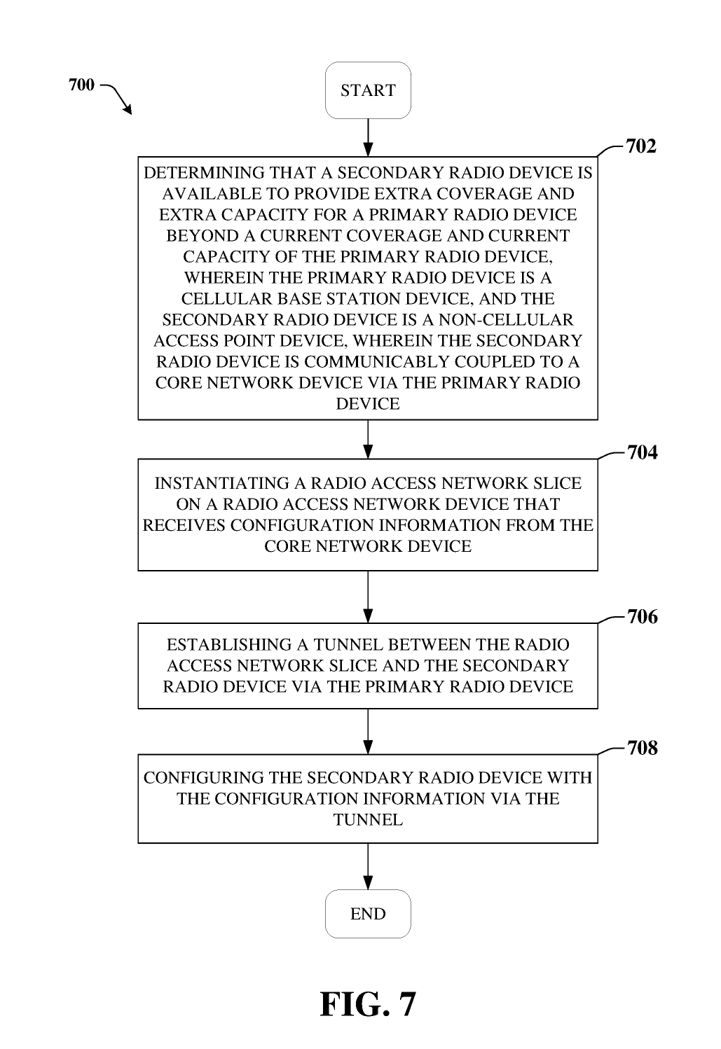

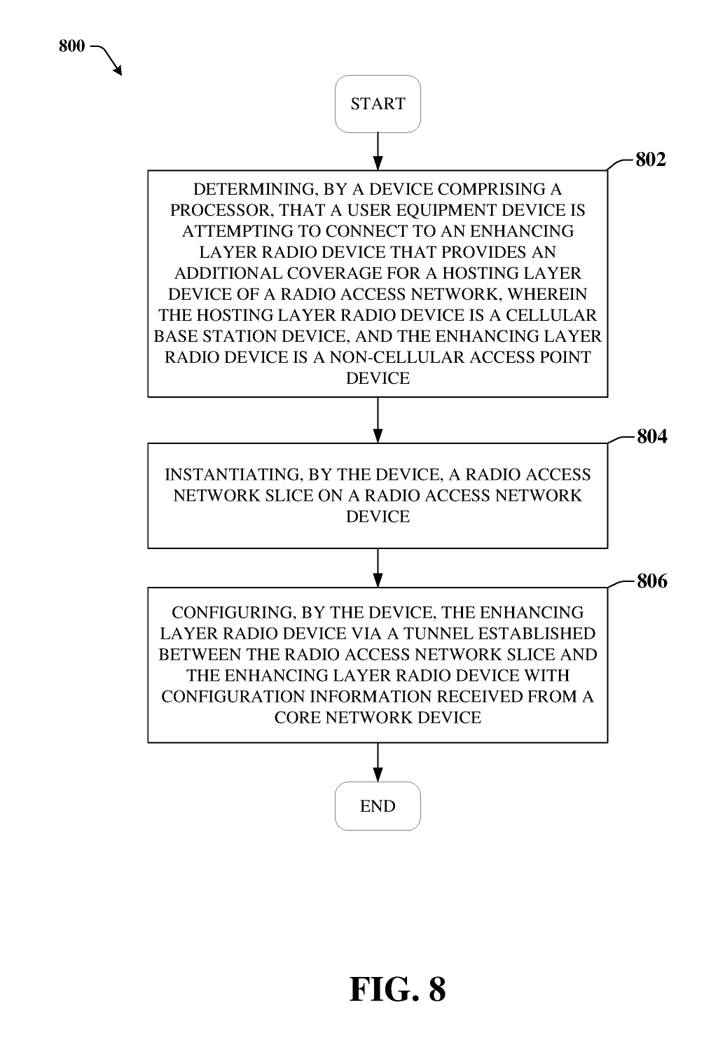

FIGS. 7-8 illustrates processes in connection with the aforementioned systems. The process in FIGS. 7-8 can be implemented for example by the systems in FIGS. 1-6 respectively. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 7 illustrates an example method 700 for providing a dynamic slicing and pooling solution for multiple layers in a radio access network in accordance with various aspects and embodiments of the subject disclosure.

Method 700 can begin at 702 wherein the method includes determining that a secondary radio device is available to provide extra coverage and extra capacity for a primary radio device beyond a current coverage and current capacity of the primary radio device, wherein the primary radio device is a cellular base station device, and the secondary radio device is a non-cellular access point device, wherein the secondary radio device is communicably coupled to a core network device via the primary radio device.

At 704, the method can include instantiating a radio access network slice on a radio access network device that receives configuration information from the core network device.

At 706, the method can include establishing a tunnel between the radio access network slice and the secondary radio device via the primary radio device.

At 708, the method can include configuring the secondary radio device with the configuration information via the tunnel.

FIG. 8 illustrates an example method 800 for providing a dynamic slicing and pooling solution for multiple layers in a radio access network in accordance with various aspects and embodiments of the subject disclosure.

Method 800 can begin at 802 wherein the method includes determining, by a device comprising a processor, that a user equipment device is attempting to connect to an enhancing layer radio device that provides an additional coverage for a hosting layer device of a radio access network, wherein the hosting layer radio device is a cellular base station device, and the enhancing layer radio device is a non-cellular access point device.

At 804, the method can include instantiating, by the device, a radio access network slice on a radio access network device.

At 806, the method can include configuring, by the device, the enhancing layer radio device via a tunnel established between the radio access network slice and the enhancing layer radio device with configuration information received from a core network device.

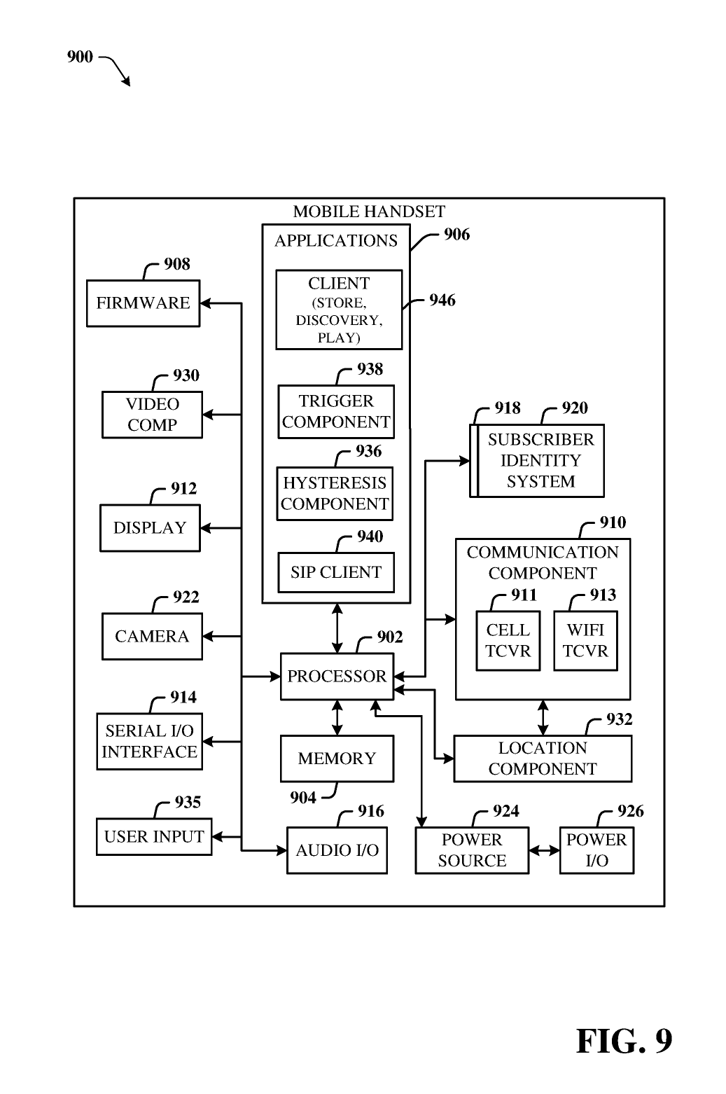

Referring now to FIG. 9, illustrated is a schematic block diagram of an example end-user device such as a user equipment) that can be a mobile device 900 capable of connecting to a network in accordance with some embodiments described herein. Although a mobile handset 900 is illustrated herein, it will be understood that other devices can be a mobile device, and that the mobile handset 900 is merely illustrated to provide context for the embodiments of the various embodiments described herein. The following discussion is intended to provide a brief, general description of an example of a suitable environment 900 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 900 includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1394) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communication component 910 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 922 (e.g., a camera) can be provided for decoding encoded multimedia content. The video processing component 922 can aid in facilitating the generation, editing and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 938 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 810, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

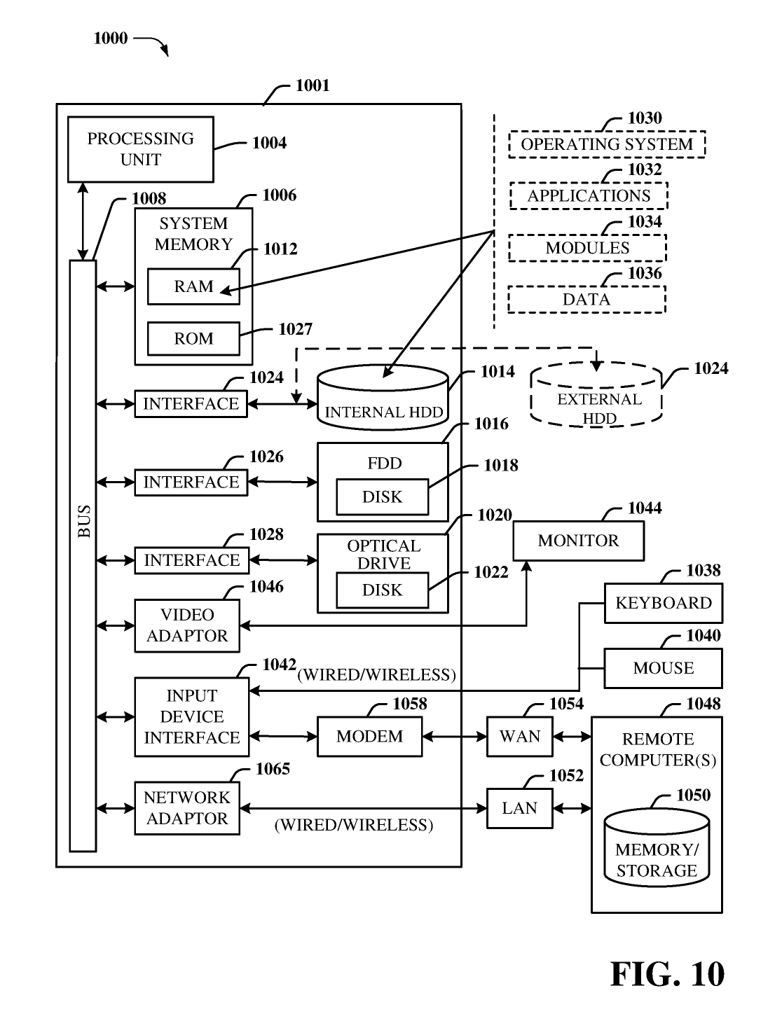

Referring now to FIG. 10, there is illustrated a block diagram of a computer 1000 operable to execute the functions and operations performed in the described example embodiments. For example, a network node (e.g., network node 406) may contain components as described in FIG. 10. The computer 1000 can provide networking and communication capabilities between a wired or wireless communication network and a server and/or communication device. In order to provide additional context for various aspects thereof, FIG. 10 and the following discussion are intended to provide a brief, general description of a suitable computing environment in which the various aspects of the embodiments can be implemented to facilitate the establishment of a transaction between an entity and a third party. While the description above is in the general context of computer-executable instructions that can run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 10, implementing various aspects described herein with regards to the end-user device can include a computer 1000, the computer 1000 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1027 and random access memory (RAM) 1012. A basic input/output system (BIOS) is stored in a non-volatile memory 1027 such as ROM, EPROM, EEPROM, which BIOS contains the basic routines that help to transfer information between elements within the computer 1000, such as during start-up. The RAM 1012 can also include a high-speed RAM such as static RAM for caching data.

The computer 1000 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject embodiments.

The drives and their associated computer-readable media provide nonvolatile storage of data, data structures, computer-executable instructions, and so forth. For the computer 1000 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1000, such as zip drives, magnetic cassettes, flash memory cards, cartridges, and the like, can also be used in the example operating environment, and further, that any such media can contain computer-executable instructions for performing the methods of the disclosed embodiments.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the various embodiments can be implemented with various commercially available operating systems or combinations of operating systems.

A user can enter commands and information into the computer 1000 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 through an interface, such as a video adapter 1046. In addition to the monitor 1044, a computer 1000 typically includes other peripheral output devices (not shown), such as speakers, printers, etc.

The computer 1000 can operate in a networked environment using logical connections by wired and/or wireless communications to one or more remote computers, such as a remote computer(s) 1048. The remote computer(s) 1048 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1000 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1000 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 through the input device interface 1042. In a networked environment, program modules depicted relative to the computer, or portions thereof, can be stored in the remote memory/storage device 1050. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor, facilitate performance of operations, comprising:
determining that a secondary radio device is available to provide extra coverage and extra capacity for a primary radio device beyond a current coverage and current capacity of the primary radio device, wherein the primary radio device is a cellular base station device, and the secondary radio device is a non-cellular access point device, wherein the secondary radio device is communicably coupled to a core network device via the primary radio device;
instantiating a radio access network slice on a radio access network device that receives configuration information from the core network device;
facilitating establishing a tunnel between the radio access network slice and the secondary radio device via the primary radio device; and
configuring the secondary radio device with the configuration information via the tunnel.

2. The system of claim 1, wherein the operations further comprise:
transmitting user plane data and control plane data between the core network device and the secondary radio device via the radio access network slice and the tunnel.

3. The system of claim 1, wherein the operations further comprise:
identifying a type of device of the secondary radio device based on matching identifying information received from the secondary radio device to matching information in a data store.

4. The system of claim 1, wherein the instantiating the radio access network slice comprises:
selecting the radio access network slice from a group of radio access network slices based on a type of the secondary radio device.

5. The system of claim 1, wherein the operations further comprise:
selecting the radio access network slice from a group of radio access network slices based on a network service requested by a user equipment device attached to the secondary radio device.

6. The system of claim 1, wherein the primary radio device is part of a hosting layer of a radio access network and the secondary radio device is part of an enhancing layer of the radio access network.

7. The system of claim 1, wherein the secondary radio device is at least one of a Wi-Fi device, a femtocell device, or a range extender device.

8. The system of claim 1, wherein the operations further comprise:
forwarding data, which was received by a common slice of the radio access network device, to the radio access network slice via a slice selection network function.

9. The system of claim 1, wherein the instantiating comprises instantiating a group of radio access network slices comprising the radio access network slice, and
wherein the establishing the tunnel comprises concurrently establishing respective tunnels, comprising the tunnel, for a group of secondary radio devices, comprising the secondary radio device.

10. The system of claim 1, wherein the determining that the secondary radio device is available to provide the extra coverage and the extra capacity for the primary radio device is in response to determining that a resource usage of the primary radio device is greater than a predetermined level.

11. The system of claim 1, wherein the determining that the secondary radio device is available to provide the extra coverage and the extra capacity for the primary radio device is in response to determining that a first signal to noise ratio of a first transmission between a user equipment device and the primary radio device is less than a first predetermined signal to noise ratio level, and that a second signal to noise ratio of a second transmission between the user equipment device and the secondary radio device is greater than a second predetermined signal to noise ratio level.

12. A method, comprising:
determining, by a device comprising a processor, that a user equipment device is attempting to connect to an enhancing layer radio device that provides an additional coverage for a hosting layer device of a radio access network, wherein the hosting layer radio device is a cellular base station device, and the enhancing layer radio device is a non-cellular access point device;
instantiating, by the device, a radio access network slice on a radio access network device; and
configuring, by the device, the enhancing layer radio device via a tunnel established between the radio access network slice and the enhancing layer radio device with configuration information received from a core network device.

13. The method of claim 12, further comprising:
facilitating, by the device, establishing the tunnel between the radio access network slice and the enhancing layer radio device via the hosting layer radio device.

14. The method of claim 12, further comprising:
facilitating, by the device, transmitting user plane data and control plane data between the core network device and the enhancing layer radio device via the radio access network slice and the tunnel.

15. The method of claim 12, further comprising:
identifying, by the device, a type of the enhancing layer radio device based on matching identifying information received from the enhancing layer radio device to matching information in a data store.

16. The method of claim 15, further comprising:
selecting, by the device, the radio access network slice from a group of radio access network slices based on the type of the enhancing layer radio device.

17. The method of claim 12, further comprising:
selecting, by the device, the radio access network slice from a group of radio access network slices based on a network service requested by the user equipment device.

18. A machine-readable storage medium, comprising executable instructions that, when executed by a processor of a device, facilitate performance of operations, comprising:
determining that a user equipment device is attempting to connect to a secondary radio device that provides backup coverage for a coverage of a primary device of a radio access network, wherein the secondary radio device is communicably coupled to a core network device via the primary radio device;
causing a radio access network slice to be instantiated on a radio access network device; and
configuring the secondary radio device via a tunnel established between the radio access network slice and the secondary radio device with configuration information received from the core network device.

19. The machine-readable storage medium of claim 18, wherein the operations further comprise:
establishing the tunnel between the radio access network slice and the secondary radio device via the primary radio device.

20. The machine-readable storage medium of claim 18, wherein the operations further comprise:
selecting the radio access network slice from a group of radio access network slices based on a network service requested by the user equipment device attached to the secondary radio device.
